(19) United States
(12) Patent Application Publication
(10) Pub. No.: US 2011/0230627 A1
(43) Pub. Date: Sep. 22, 2011

(54) METHOD FOR OPTIMISING THE SUPPLY OF CATALYST SLURRY TO A POLYMERIZATION REACTOR

(75) Inventor: Rudi Tanghe, St.-Lenaarts (BE)

(73) Assignee: TOTAL PETROCHEMICALS RESEARCH FELUY, Seneffe (Feluy) (BE)

(21) Appl. No.: 13/126,194

(22) PCT Filed: Nov. 18, 2009
(86) PCT No.: PCT/EP2009/065399

§ 371 Date: Apr. 27, 2011

(30) Foreign Application Priority Data
Jan. 18, 2008 (EP) 08169357.4

(51) Int. Cl. C08F 2/01; B01J 19/00

(52) U.S. Cl. 526/60; 422/131

(57) ABSTRACT

The present invention relates to a method for optimizing the supply of a catalyst slurry during a polymerization process for preparing a polyolefin in a polymerization reactor (1), whereby said slurry consists of solid catalyst particles suspended in a hydrocarbon diluent and is characterised by a ratio of solid catalyst particles/diluent, whereby the catalyst slurry is fed to the reactor through at least two parallel catalyst feeding conduits (4, 104) which are intermittently operative in the polymerisation process, said method comprising the steps of:
determining an effective initial ratio solid catalyst particles/diluent for the polymerization process;
determining the actual ratio solid catalyst particles/diluent in a first operative feeding conduit (4);
calculating the difference between actual and initial ratio and in the event that said difference is more than a specified threshold, shutting down the first catalyst feeding conduit (4) and activating a second catalyst feeding conduit (104).

The catalyst slurry is periodically supplied to the reactor. The invention also relates to polyolefin production processes and polyolefin producing units.

### FIELD OF THE INVENTION

This invention relates to catalytic olefin polymerisation reactions. In particular, the invention relates to a method for regulating the supply of catalyst slurry to a polymerization reactor during a polymerization process for preparing a polyolefin which is based on the determination of the ratio of solid catalyst particles/diluent in the catalyst slurry and thus of the concentration of solid catalyst particles in the catalyst slurry before supplying said catalyst slurry to said reactor. The invention also relates to a polymerization unit comprising means for regulating the supply of catalyst slurry to a polymerisation reactor.

### BACKGROUND ART

It is known that the polymerisation of olefins e.g. ethylene, especially by a gas phase polymerisation process, involves the polymerisation of olefin monomer with the aid of catalyst and optionally, if required depending on the used catalyst, a co-catalyst. Suitable catalysts for use in the production of polyolefins comprise chromium-type catalysts, Ziegler-Natta catalysts and metallocene catalysts.

Several systems have been disclosed which involve the preparation and the supply of diluted catalyst slurry to a polymerization reaction. In general, for preparing catalyst slurry, a mixture of dry solid particulate catalyst and diluent are apportioned in a catalyst storage vessel and thoroughly mixed. Then such catalyst slurry is typically transferred directly to a polymerization reactor for contact with the monomer reactants, generally under high pressure conditions.

Polymerisation reactions are sensitive to the quantity of catalyst utilized. Variations in the amount of catalyst injected in the polymerization reactor can detrimentally affect the polymerisation process. Unexpected or uncontrolled catalyst injection in a reactor could lead to runaway reactions. In addition, the polymerization product will be inhomogeneous and possibly even off-specification. More in particular, fluctuations in the polymerisation conditions and notably any increases in the amount of catalyst injected, could lead to reactions that exceed cooling capacity of a reactor, that could thus result in overheating and eventually plugging of the reactor. In such cases, the polymerization reactor must be shut down, creating a substantial loss in polymerization product and entailing costs.

An important problem in the injection of catalyst slurry into a reactor in prior art methods is that it is difficult to control the amount of the catalyst injected.

Conventional systems for controlling polymerization processes are based on sampling and analysing of a polymerisation product downstream of the polymerization reactor. Indirectly, to determine if suitable amounts of catalyst have been injected in the reactor, polymerization products (polyolefin sample) issuing from the reaction are analyzed. These control systems are time intensive and analytical results are usually available only every two to four hours. In commercial scale polymerisation processes, many thousands of tons of polymerisation product can be produced in this time span. Accordingly, conventional control systems may result in the production of a large amount of product off specification and furthermore cannot prevent sudden overheating and reactor shutdown.

Methods have been disclosed wherein catalyst supply to a polymerisation reactor is controlled in function of the concentration of a reactant in the polymerisation reactor.

In an example, WO 2005/077522 discloses a method for controlling the supply of catalyst slurry to a polymerisation reactor based on the concentration of a reactant, e.g. ethylene, in the reactor. The method comprises the transfer of catalyst slurry in the reactor at a controlled flow rate. It is noted that in the disclosed method catalyst slurry is continuously supplied to the reactor. To that end, a catalyst preparation unit is provided which comprises inter alia a storage vessel, wherein concentrated catalyst slurry is prepared and a buffer vessel, connected thereto, wherein diluted catalyst slurry is prepared. Diluted catalyst slurry is continuously pumped through a conduit from such buffer vessel to the reactor at a suitable flow rate. The disclosed method and catalyst preparation unit enable continuous supply of diluted catalyst slurry to the reactor without interruption of the catalyst flow.

In view of the above, it is clear that there remains a need in the art for a method permitting to control or regulate the amount of catalyst injected into a polymerization reactor.

There is also a need in the art for alternative method permitting to discontinuously supply of catalyst slurry in a controlled way into a polymerization reactor.

It is an object of the present invention to provide for a method for the delivery of catalyst to a polymerization reactor wherein at least one of the above-mentioned drawbacks is overcome.

It is in particular an object of the present invention to provide a method for discontinuously and reliably delivering catalyst slurry into a loop reactor.

### SUMMARY

To this end, the present invention provides a method for regulating the supply of catalyst slurry to a polymerization reactor, and in particular provides a method for monitoring and controlling the amount of catalyst slurry injected into a polymerization reactor. In particular, the invention provides a method for discontinuously delivering catalyst slurry into a loop reactor at a concentration which is suitable for use in a polymerisation reaction. More in particular, catalyst slurry is introduced discontinuously at prescribed time intervals into a polymerization reactor.

In a first aspect, the present invention thereto provides a method for optimizing the supply of a catalyst slurry during a polymerization process for preparing a polyolefin in a polymerization reactor, whereby said slurry consists of solid catalyst particles suspended in a hydrocarbon diluent and is characterised by a ratio of solid catalyst particles/diluent, whereby the catalyst slurry is fed to the reactor through at least two parallel catalyst feeding conduits which are intermittently operative in the polymerisation process, said method comprising the steps of :
determining an effective initial ratio solid catalyst particles/diluent for the polymerization process;
determining the actual ratio solid catalyst particles/diluent in a first operative feeding conduit;
calculating the difference between actual and initial ratio and in the event that said difference is more than a specified threshold, shutting down the first catalyst feeding conduit and activating a second catalyst feeding conduit.

Advantageously the present invention has the effect of permitting to fine-tune catalyst supply to a polymerization reactor during a polymerization process. The polymerization production conditions and rate in the reactor can be controlled by controlling the amount of catalyst fed to the reactor. According to this aspect the reactor is fed with an adequate and optimal concentration of catalyst slurry at a suitable feed rate, and as a consequence the productivity in the polymerisation reactor and consistency of the polymerisation product are considerably improved. Fluctuations in the properties and quality of the polymerisation product resulting from the polymerisation reaction are substantially avoided, and also interruptions of the polymerization process (e.g. reactor shutdown) can be avoided.

In comparison to prior art techniques, the present invention allows the constant monitoring of catalyst quantities entering a polymerization reactor with each injection of catalyst slurry, since the present method permits to measure on-line and continuously the amount of catalyst injected into a polymerisation reactor in a particular reliable way. Thus, it is possible to determine when a catalyst feeding system is no longer functioning as desired.

Once this occurs, it is possible to switch to a parallel catalyst feeding system while the first feeding system is repaired, thereby avoiding costly shutdowns.

In a preferred embodiment, a method is provided for optimizing the supply of a catalyst slurry during a polymerization process for preparing a polyolefin in a polymerization reactor, whereby said slurry consists of solid catalyst particles suspended in a hydrocarbon diluent and characterised by a ratio of solid catalyst particles/diluent, whereby the catalyst slurry is periodically supplied to the reactor through at least two parallel catalyst feeding conduits which are intermittently operative in the polymerisation process, said method comprising the steps of:
determining an effective initial ratio solid catalyst particles/diluent for the polymerization process;
determining the actual ratio solid catalyst particles/diluent in a first operative feeding conduit;
calculating the difference between actual and initial ratio and in the event that said difference is more than a specified threshold, shutting down the first catalyst feeding conduit and activating a second catalyst feeding conduit.

More in particular, the invention provides a method comprising periodically supplying said catalyst slurry to said polymerization reactor, i.e. a method comprising injecting said catalyst slurry at regular time intervals to said polymerization reactor.

In another preferred embodiment, the invention provides a method comprising supplying a defined volume of catalyst slurry at regular time intervals to said polymerization reactor.

In a preferred embodiment, a method is provided wherein said regular time intervals consist of time intervals of every 5 to 30 seconds, and for instance every 5, 10, 15, 20, 25 or 30 seconds.

In another preferred embodiment, a method is provided wherein said defined volume is comprised between 10 and 100 cc (cm³).

The present method is characterised in that the actual ratio solid catalyst particles/diluent is determined continuously and on-line. In a particular embodiment, the method of the invention involves the determination of the actual ratio solid catalyst particles/diluent in said catalyst slurry by measuring the flow and density of the catalyst slurry, and by correlating said measured flow and density to said actual ratio solid catalyst particles/diluent, and thus to the actual concentration of catalyst solids in the slurry. Preferably, determination of the actual concentration of solid catalyst particles in said catalyst slurry is performed by means of a flow measuring device which is provided upstream of the polymerization reactor on the catalyst feeding conduit.

In another aspect, the invention provides a polyolefin producing unit, comprising:
a reactor system comprising at least one polymerization reactor,
means for feeding monomer, optionally co-monomer, and diluent to at least one polymerization reactor,
means for supplying a catalyst slurry consisting of solid catalyst particles suspended in a hydrocarbon diluent and characterised by a ratio of solid catalyst particles/diluent to said at least one polymerization reactor whereby said means comprise a storage vessel for storing catalyst slurry, which is operably connected to at least two parallel catalyst feeding conduits, whereby said conduits connect said storage vessel to said polymerization reactor,
one or more monomer and/or diluent recovery systems configured to recover unreacted monomer and/or diluent discharged from the polymerization reactor, and
a polyolefin processing system configured to process polyolefin particles produced in said polymerization reactor,
   characterized in that each of said catalyst feeding conduits is provided with:
a metering device for measuring a defined volume of catalyst slurry and periodically releasing said defined volume to said catalyst feeding conduits, and
a flow measuring device for determining the ratio of solid catalyst particles/diluent in said catalyst slurry, whereby said measuring device is provided on said catalyst feeding conduit downstream of said metering device.

More in particular, said polyolefin producing unit is characterized in that each of said catalyst feeding conduits is provided with:
an inlet, which is connected to said storage vessel and an outlet, which is connected to said reactor;
a metering device for measuring a defined volume of catalyst slurry and periodically releasing said defined volume from said storage vessel to said catalyst feeding conduits, and
a flow measuring device for determining the ratio of solid catalyst particles/diluent in said catalyst slurry, whereby said measuring device is provided on said catalyst feeding conduit downstream of said metering device.

In accordance with the present invention, the storage vessel is directly connected by means of said catalyst feeding conduits to the polymerisation reactor, and the metering device and the flow measuring means are installed on each of these feedings conduits. The presence of metering devices on the catalyst feedings conduits permits to periodically deliver a defined volume of catalyst slurry from said storage vessel to said catalyst feeding conduits, and thus from the storage vessel to the reactor.

The storage vessel according to the present invention contains catalyst slurry having a concentration which is suitable for use in the polymerisation reactor. In particular, such storage vessel contains diluted catalyst slurry, having a concentration comprised between 0.1 and 10% by weight.

In a preferred embodiment, said parallel catalyst feeding conduits are intermittently operative during the polymerisation process.

In another preferred embodiment, said catalyst feeding conduits comprise diluent injection means which are provided downstream of said metering device and upstream of said flow measuring device. These injection means are particularly suitable for enabling dilution of catalyst slurry in line while transferring slurry from the storage vessel to the reactor.

In another preferred embodiment, said catalyst feeding conduits are provided with valves for closing said conduits when not operative, whereby valves are provided on said conduits in between the storage vessel and the metering devices and valves are provided on said conduits between the flow measuring means and the reactor.

In yet another preferred embodiment, said metering device is a ball check feeder valve.

In still another preferred embodiment, said flow measuring device is a coriolis meter.

The invention also relates to polyolefin production processes wherein the herein disclosed method for optimising or regulating the supply of catalyst slurry to a polymerization reactor is applied.

The various features which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### DESCRIPTION OF THE FIGURES

FIG. 1 represents a simplified diagram of a catalyst feeding system according to an embodiment of the present invention.

FIG. 2 represents an embodiment of a ball check feeder valve, which can be used in the present method and feeding system for measuring a defined volume of catalyst slurry and periodically releasing said defined volume to a polymerization reactor through a catalyst feeding conduit.

FIG. 3 represents the periodical supply of catalyst to a polymerisation reactor at a catalyst flow rate on a scale of 0-10 kg/h. The reactor temperature is represented on a scale of between 90 and 100° C. An “alarm” value of catalyst flow rate has been programmed. The figure illustrates that the amount of catalyst that is periodically injected in a reactor significantly changes with each injection, thus indicating that the amount of catalyst that is periodically injected is not constant and that the catalyst feeding system is inaccurate and should be replaced or repaired to avoid reactor shutdown.

FIG. 4 also represents the periodical supply of catalyst to a polymerisation reactor at a catalyst flow rate on a scale of 0-5 kg/h. An “alarm” value of catalyst flow rate has been programmed. The reactor temperature is represented on a scale of between 90 and 95° C. The operation temperature is about 92° C. in this case it can be seen that the amount of catalyst periodically injected is relatively constant with each injection and that the catalyst feeding system operates adequately. The reactor temperature is constant and the catalyst flow is below 5 kg/h.

### DETAILED DESCRIPTION OF THE INVENTION

The present invention is especially applicable to catalytic olefin polymerisation processes. The present invention is directed to a method for regulating the supply of catalyst slurry to a polymerisation reactor wherein polyolefins are prepared.

Catalytic olefin polymerization processes may include homo-polymerization or co-polymerization of olefin monomers and at least one olefin co-monomer. Olefin polymerization comprises feeding to a reactor the reactants including the olefin monomer, one or more optional co-monomer(s), a diluent, a catalyst, optionally a co-catalyst, and a terminating agent such as hydrogen.

Olefin monomers may for instance comprising ethylene or propylene.

Olefin co-monomers which are suitable for being used in accordance with the present invention may comprise but are not limited to aliphatic C₃-C₂₀ alpha-olefins. Examples of suitable aliphatic C₃-C₂₀ alpha-olefins include propylene, 1-butene, 4-methyl-1-pentene, 1-hexene, 1-octene, 1-decene, 1-dodecene, 1-tetradecene, 1-hexadecene, 1-octadecene and 1-eicosene. In a preferred embodiment of the present invention, said co-monomer is 1-hexene. However, it should be clear from the present invention that other co-monomers may as well be applied according to the present invention.

Diluents which are suitable for being used in accordance with the present invention may comprise but are not limited to hydrocarbon diluents such as aliphatic, cycloaliphatic and aromatic hydrocarbon solvents, or halogenated versions of such solvents. The preferred solvents are C₁₂ or lower, straight chain or branched chain, saturated hydrocarbons, C₅ to C₉ saturated alicyclic or aromatic hydrocarbons or C₂ to C₆ halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane. In a preferred embodiment of the present invention, said diluent is isobutane. However, it should be clear from the present invention that other diluents may as well be applied according to the present invention.

Catalytic olefin polymerization processes utilize highly sophisticated catalyst systems that initiate polymerization and propagate the reaction. According to the present invention the term “catalyst” is defined herein as a substance that causes a change in the rate of a polymerization reaction without itself being consumed in the reaction. Suitable catalysts and for use in the polymerization of olefins are well known in the art.

In one embodiment of the invention, the catalyst is a chromium catalyst. The term “chromium catalysts” refers to catalysts obtained by deposition of chromium oxyde on a support, e.g. a silica or aluminum support. Illustrative examples of chromium catalysts comprise but are not limited to CrSiO₂ or CrAl₂O₃.

As used herein, the term “catalyst slurry” refers to a composition comprising catalyst solid particles that are in suspension in a diluent. Catalyst slurry is also characterised by a certain ratio of catalyst solid particles to the hydrocarbon diluent. A “suitable ratio of solid catalyst particles/diluent” in this context thus inherently refers to a suitable concentration of solids in the catalyst slurry, and depends e.g. on the polymerization reaction, e.g. types of reactants, and reaction conditions, e.g. temperature, stage (start, end) of the polymerisation process, etc. Solid catalyst particles/diluent ratio's that are required at various stages of the polymerization process can be (theoretically) determined or calculated by a person skilled in the art.

The present invention is in particular described with reference to the supply of chromium catalyst diluted in isobutane diluent to a slurry loop polymerisation reactor wherein ethylene is polymerised. However, it shall be clear that the present invention is not limited thereto and the method and devices for optimising or regulating the supply of catalyst slurry to a polymerization reactor are equally applicable to polymerization processes wherein other polyolefins are prepared, e.g. propylene.

It is known in the art that in olefin slurry polymerizations, catalyst is generally fed into the reactor through one or more catalyst feeding conduits. However, due to degradation or damage to the catalyst feeding conduits and elements thereof, e.g. leaks in the conduit, pumps, valves, etc, causing too much catalyst to be injected or mechanical deformations causing too little of the catalyst to be injected, the amount of catalyst entering the reactor with each injection may begin to fluctuate. Variations in the quantity of catalyst injected can detrimentally affect the polymerisation process, resulting in a polymerization product that will be inhomogeneous and possibly even off-specification. The fluctuations in the polymerization conditions and notably any increases in amount of catalyst injected, may result in overheating and eventually plugging of the polymerization reactor. Consequently, the reactor must be shut down, creating a substantial loss in product.

The present invention provides a method for on-line and continuously determining the real amount of catalyst slurry consisting of solid catalyst particles suspended in a hydrocarbon diluent fed to a polymerization reactor. Continuously measuring of the real amount of catalyst slurry “on-line” refers to measurements which are continuously performed directly in the process line (feeding conduit) to the reactor, and which provide a continuous measurement of the quantity of catalyst slurry.

In accordance with the present invention, a catalyst slurry which consists of solid catalyst particles suspended in a hydrocarbon diluent and which is characterised by a ratio of solid catalyst particles/diluent is fed during a polymerization process for preparing a polyolefin in a polymerization reactor to this reactor through at least two parallel catalyst feeding conduits which are intermittently operative in the polymerisation process.

The term “intermittently operative” as used herein indicates that the two (or more) catalyst feeding conduits are not simultaneously operative, but that during the polymerisation process one catalyst feeding conduit is operative while the other catalyst feeding system(s) is (are) inoperative, i.e. is (are) kept in standby mode, no catalyst slurry is supplied through these conduit(s) to the reactor, but the conduit(s) can be instantly activated in case the first catalyst conduit needs to be closed or shut down.

In particular, the method for optimizing the supply of a catalyst slurry during a polymerization process comprises the steps of:
determining an effective initial ratio solid catalyst particles to diluent for the polymerization process;
determining the actual ratio solid catalyst particles to diluent in a first operative feeding conduit;
calculating the difference between actual and initial ratio and in the event that said difference is more than a specified threshold, shutting down the first catalyst feeding conduit and activating a second catalyst feeding conduit.

The term “effective initial” ratio solid catalyst particles/diluent (Ri) as used herein refers to a theoretically calculated ratio of solid catalyst to diluent which is required for efficiently/effectively preparing a polyolefin complying with prescribed product characteristics such as e.g. density, melt index, etc.

The term “actual” ratio solid catalyst particles/diluent (Ra) as used herein refers to the ratio of solid catalyst to diluent, and thus to the concentration of solid catalyst particles in the catalyst slurry, that is determined or measured before the catalyst slurry is injected in the reactor.

In accordance with the present invention, this actual solid catalyst particles/diluent ratio is determined with a flow measuring device, which is provided on the feeding conduit for feeding the catalyst slurry to the polymerization reactor. Said flow measuring device is capable of measuring flow and density of the catalyst slurry and programmed to derive there from the concentration of catalyst solids and thus the ratio of solids to diluent in the catalyst slurry. Preferably this flow measuring device is a coriolis meter. The software of such coriolis meter can be programmed as to contain known correlation data between diluent density and solids concentration. The amount of catalyst solids entering the reactor can therefore be accurately determined in accordance with the present method.

The present method further involves the step of comparing the actual with the initial ratio of solid catalyst particles to diluent and calculating the difference between actual and initial ratio, given by the equation (1):

Δ=|Ri−Ra| (1).

In the case that this calculated difference deviates from, or in other words is more or less than a specified threshold difference (Δt), thus

If Δ≠Δt (2)

the present method comprises the actions of shutting down the first catalyst feeding conduit and activating a second catalyst feeding conduit.

The “threshold difference” in this context refers to a difference between initial ratio and actual ratio of solid catalyst particles to diluent which is still acceptable for efficiently preparing a polyolefin complying with prescribed product characteristics such as e.g. density, melt index, etc. This threshold difference may differ dependent on the polymerisation reactants and conditions. In one example, for instance in the case of polyethylene preparation, said threshold difference may be 10%, which indicates that a deviation (difference) between actual and initial ratio with more then 10% is no longer acceptable.

The present invention is based on a discontinuous feed of catalyst slurry to a polymerization reactor; in contrast to prior art methods, such as the method disclosed in WO 2005/077522, which involve a continuous supply of a catalyst slurry into a polymerization reactor.

In an embodiment, the present invention thus relates to a method comprising periodically supplying said catalyst slurry to a polymerization reactor, for instance by injecting catalyst slurry at certain time-points, and preferably at regular time intervals during the polymerization process, into the reactor. The term “periodically” is used herein as synonym for “discontinuously” or “intermittently”, and indicates that catalyst slurry is injected at certain defined time points in the polymerization reactor, this contrary to a continuous (i.e. non-stop) injection of catalysts slurry in a polymerization reactor. In a preferred embodiment, the present method comprises supplying catalyst slurry at regular time intervals, e.g. every 5 to 30 seconds and for instance every 5, 10, 15, 20, 25, 30 seconds, to said polymerization reactor.

In another embodiment, the present invention relates to a method comprising supplying a defined volume of catalyst slurry at regular time intervals to said polymerization reactor. The term “defined volume” as used herein refers to a fixed amount of catalyst slurry that has been calculated as a function of the polymerisation reaction. A metering device such as a ball check feeder valve as disclosed below can be used to measure a defined volume of catalyst slurry that is to be fed to the polymerization reactor. A defined volume of catalyst slurry fed to the polymerization reactor may vary as a function of the polymerization conditions, and is for instance comprised between 10 and 100 cc(cm³), and for instance is 10, 20, 30, 40, 50, 60, 70, 80, 90 cc (cm³). In another preferred embodiment, the present method comprises supplying a defined volume as given above of catalyst slurry at regular time intervals, e.g. every 5 to 30 seconds and for instance every 5, 10, 15, 20, 25, 30 seconds, to said polymerization reactor.

In another preferred embodiment, the invention provides a method wherein the concentration of the catalyst slurry that is supplied to said polymerization reactor is comprised between 0.1 and 10% by weight.

In another aspect, the invention provides a polyolefin producing unit, comprising means for supplying a catalyst slurry consisting of solid catalyst particles suspended in a hydrocarbon diluent and characterised by a ratio of solid catalyst particles/diluent to said at least one polymerization reactor whereby said means comprise a storage vessel for storing catalyst, which is operably connected to at least two parallel catalyst feeding conduits. The means for supplying a catalyst slurry are characterized in that each of said catalyst feeding conduits is provided with:
a metering device for measuring a defined volume of catalyst slurry and periodically releasing said defined volume to said catalyst feeding conduits, and
a flow measuring device for determining the ratio of solid catalyst particles to diluent in said catalyst slurry, whereby said flow measuring device is provided on said catalyst feeding conduit downstream of said metering device.

In addition, the means for supplying a catalyst slurry are characterized in that each of said catalyst feeding conduits is provided with an inlet, which is connected to the storage vessel and an outlet, which is connected to said reactor.

The catalyst feeding conduits according to the invention provide a direct connection of the polymerisation reactor to a storage vessel, wherein diluted catalyst slurry is prepared, i.e. catalyst slurry of a concentration comprised for instance between 0.1 and 10 wt %.

The term “catalyst feeding system” as used herein intends to encompass a catalyst feeding conduit which connects a catalyst storage vessel to a polymerisation reactor and which is equipped with a metering device (valve) and a flow measuring device.

In a preferred embodiment, said parallel catalyst feeding conduits are intermittently operative during the polymerisation process. For instance, at least two catalyst feeding conduits are provided having an inlet interconnected with the catalyst storage vessel and an outlet interconnected with the polymerisation reactor. During a polymerisation process only one catalyst feeding conduit is operative while the catalyst feeding system(s) is (are) inoperative, i.e. is (are) kept in standby mode, but can be activated in case the first catalyst conduit is closed or shut down.

The term “conduit” refers to any piping, tubing, tube, etc. configured to pass catalyst slurry therethrough.

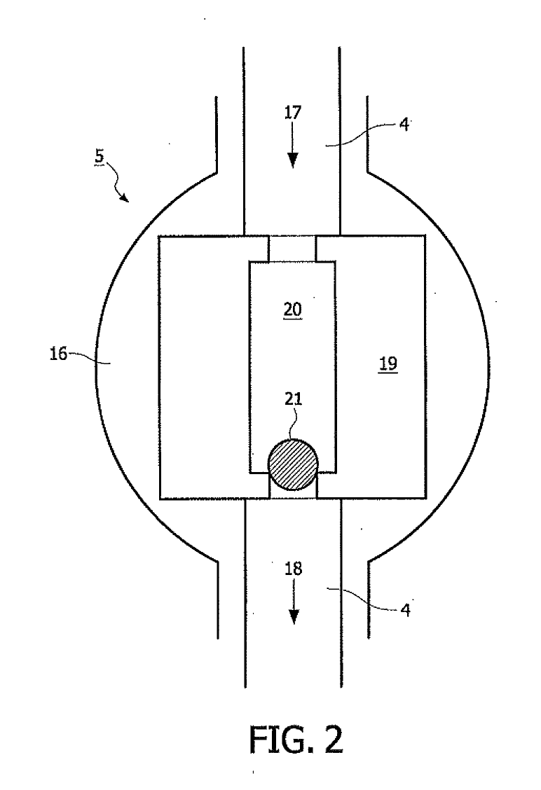

The “metering device” for measuring a predetermined volume of a mixture of catalyst and diluent preferably is a metering valve, and may for instance be a ball check feeder valve. Such valve delivers a defined volume of catalyst slurry from storage vessel to the reactor through a catalyst conduit. The working mechanism of a ball check feeder valve, involves a sequence of charging, valve actuation and dumping of a specific volume of catalyst slurry from a storage vessel to the reactor. FIG. 2 illustrates a ball check feeder valve suitable for utilization in the present method and the present feeding system. However, it is clear that other types of valves could be used as well in accordance to the present invention.

Referring to FIG. 2, a preferred embodiment of a ball check feeder valve 5 is represented which includes a body 16, having an inlet 17 and an outlet 18, a member 19, containing a metering chamber 20, which is rotatable within the body 16 for communicating with the inlet 17 and outlet 18 in at least two positions, a ball shaped piston 21, which moves with a reciprocating motion within the chamber 20 as the member is rotated. The working mechanism of such valve involves a sequence of charging, valve actuation and dumping of a specific volume of catalyst slurry from a storage vessel 2 to a polymerization reactor. During operation, when the valve takes a first position, a fixed quantity of concentrated slurry flows through the inlet 17 and fills a chamber 20 within the valve 5. Said quantity is released to the part of the feeding conduit 4 located downstream the valve when the valve is actuated to a second position. The valve 5 thus delivers a fixed volume of concentrated slurry from storage vessel 2.

During operation, when the valve takes a first position, a fixed quantity of concentrated slurry flows through the inlet of the valve and fills a chamber within the valve. Periodically this ball check feeder valve is actuated to a second position and this volume of the mixture is then dumped from the valve into the reactor through the catalyst feeding conduit. The ball check feeder valve is then recharged or refilled with the predetermined volume of the mixture in preparation for actuation back to the first position where the second volume of mixture is dumped from the valve into the mixing vessel catalyst conduit. Slurry flow from storage vessel to the reactor is thus accomplished by the cyclic operation of the metering valve. Each time when actuating the valve, a defined quantity of catalyst slurry is released to the catalyst feeding system.

The “flow measuring device” preferably is a mass flow meter, also known as inertial flow meter or as coriolis flow meter. A mass flow meter is a device that measures how much fluid is flowing through a tube. It does not measure the volume of the fluid passing through the tube; it measures the amount of mass flowing through the device. Various types of coriolis flow meters exist, e.g. curved or tubular flow meters, and can be applied in the present method and unit. Operation of coriolis flow meters is based on the coriolis effect that causes a laterally vibrating tube to distort. This type of meters provides a direct measurement of mass flow. Furthermore a direct measure of the density of the fluid is obtained. A coriolis meter advantageously permits to measure mass flow and density using only one device.

In accordance with the present method, a coriolis flow meter is used which is capable of measuring the flow rate as well as the density of the catalyst slurry flowing through said meter. Instantaneous measurement of flow rate and density of the catalyst slurry allows to calculate the concentration of solids in the catalyst slurry and thus to determine the ratio of solid catalyst particles to diluent. Both flow rate and density measurements depend on the vibration of the tube. This depends on the rigidity of the tube which in turn depends on its temperature. Calculations must therefore take the temperature of the catalyst slurry into account. A colioris meter is therefore calibrated as to correlate measurements of flow and density at a certain temperature to solids concentration.

Data can be entered into the software of a coriolis meter regarding correlations between the solid concentrations of a chromium catalyst (wt % solids) and the density (g/ml) of isobutane diluent at various temperatures (° C.), in order to enable the meter to calculate concentration of catalyst solids, and ratios of solids to diluent from the measured mass flow rates and densities.

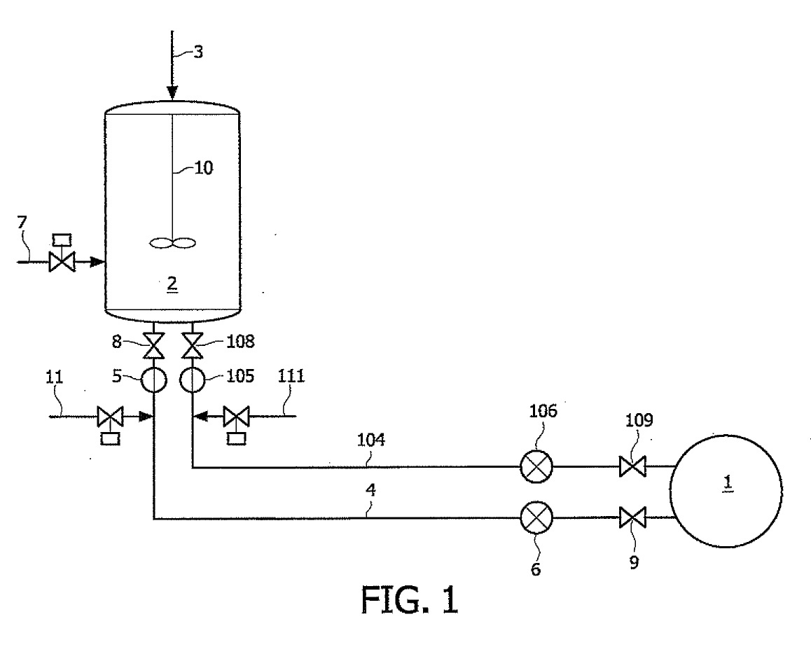

FIG. 1 schematically represents means for delivering catalyst slurry to a polymerization reactor according to an embodiment of the present invention. The constructional details of valves, pumps etc. have been omitted in the drawings for clarity reasons, it being within the skill of the art to supply these. On FIG. 1 two catalyst feeding conduits 4, 104 are illustrated. It shall be clear however that additional feeding conduits can be provided.

The means for delivering catalyst slurry comprises a storage vessel 2, which is operably connected to the polymerization reactor 1 by means of two catalyst feeding systems. Each feeding system includes a feeding conduit 4, 104 having an inlet connected to the storage vessel 2 and an outlet connected to the reactor 1. The feeding conduits 4, 104 preferably have a diameter comprised between 0.3 and 2 cm, and preferably between 0.6 and 1 cm.

Each feeding conduit 4, 104 is provided with a metering device such as a ball check feeder valve 5, 105, for supplying a defined volume of catalyst slurry into the reactor 1. The ball check feeder valve 5, 105 isolates (measures) a predetermined volume of catalyst slurry. The catalyst slurry discharged by the valve 5, 105 is then carried to the reactor by a diluent flow. Therefore, each conduit 4, 104 is preferably further provided with a port 11, 111, which can be connected for flushing with diluent. Said port 11, 111 is preferably provided downstream the valves 5, 105.

Each feeding conduit 4, 104 is also provided with a flow measuring means 6, 106. These flow measuring means 6, 106 are provided downstream of the metering devices on the conduits and preferably are coriolis meters which measure flow and density of the catalyst slurry that is supplied to the reactor. The flow measuring devices 6, 106 are preferably provided between the ball check feeder valve 5, 105 and the reactor 1.

During the polymerisation process catalyst slurry is fed from the storage vessel to the reactor through a first operative feeding conduit, while the other catalyst feeding conduit(s) are not active. This means that one conduit 4, having one active ball check feeder valve 5 and one active flow measuring device 6 will be operative during the polymerisation process, while the other conduit 104, ball check feeder valve 105 and flow measuring device 106 will not be active. In order to close the feeding conduits that are not operative valves 8, 108 are provided between the storage vessel 2 and the metering devices 5, 105, and valves 9, 109 are provided between the flow measuring means 6, 106 and the reactor 1.

It is important to control the concentration of catalyst injected into the reactor. Fluctuating amounts of catalyst supplied to the reactor could lead to reduced efficiency and fluctuations in product quality. Also, an unexpected amount of catalyst fed to the reactor could lead to a runaway reaction. Therefore, in a particularly preferred embodiment, the conduits 4, 104 are provided with flow measuring means 6, 106 for measuring the flow and density of the catalyst slurry in the conduits 4, 104 prior to injection in the reactor. These flow measuring devices 6, 106 preferably are coriolis flow measuring devices. The flow measuring devices 6, 106 preferably are tubular coriolis flow measuring devices. In an example, the flow measuring devices 6, 106 are tubular coriolis flow having an inner diameter of about 8.7 mm and an outer diameter of about 9.7 mm.

Practically, chromium catalyst particles can be unloaded from a commercial container in a buffer vessel (not shown). The buffer vessel receives the catalyst from a commercial container, under low pressure. This buffer vessel operates at nearly atmospheric pressure when unloading the catalyst container, and the catalyst can then be transferred via a conduit 3 at nearly atmospheric pressure to a storage vessel 2 which is also under nearly atmospheric pressure. The catalyst is discharged through said conduit 3 into the storage vessel 2, under atmospheric pressure.

Isobutane diluent is fed by means of conduit 7 into this storage vessel 2 equipped with a mixing unit 10 to suspend the catalyst particles in the diluent and to prepare catalyst slurry of solid chromium particles suspended in isobutane. Preferably catalyst slurry comprising solid catalyst in a hydrocarbon diluent is prepared having a concentration comprised between 0.1 and 10% by weight.

The pressure in the conduits 4, 104 is preferably comprised between 45 and 55 bar. This elevated pressure, in comparison with the pressure value provided in the vessel 2, is required in order to bring the catalyst under sufficient pressure into the reactor 1.

Chromium catalyst slurry is periodically transferred from the storage vessel 2 to a reactor 1 through one conduit 4, while the other conduit 104 is kept inactive. A ball check feeder valve 5 regulates the feed of a defined volume of chromium catalyst suspended in isobutane diluent into the reactor 1 at regular time intervals, e.g. every 5 to 30 seconds, using further isobutane diluent, which is supplied by means of conduit 11.

The coriolis meter 6 measures the flow and the density of the catalyst slurry at the exit of the ball check feeder valve 5 and indirectly determines the suspended solids concentration. The coriolis meter is programmed and calibrated as to determine the concentration of suspended solids based on the slurry density, the carrier fluid density and the solid particle density. The coriolis meter thus permits to determine from the slurry mass flow and density at particular temperatures how much catalyst solid will enter the reactor 1 by each injection of catalyst slurry.

According to the present invention, once the solid concentration of the catalyst slurry fed to the reactor by conduit 4 deviates (is more then) from a defined threshold value, conduit 4 of the system is closed and undergoes maintenance, while the second conduit 104 is activated (opened), permitting not to interrupt injection of catalyst slurry in the reactor while repairing or maintaining the first catalyst supply system.

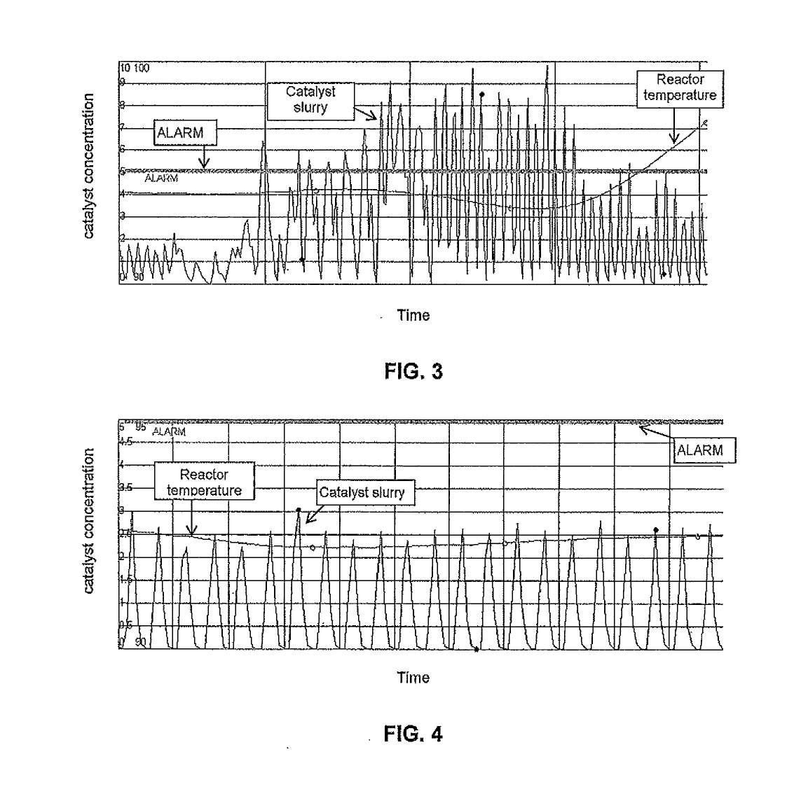

For instance, FIG. 3 shows the concentration of catalyst monitored as a function of time. As illustrated on this figure, the amount of catalyst slurry injected at defined time intervals into the polymerization reactor is highly fluctuating and causes temperature fluctuation in the reactor. This may eventually lead to a reactor shutdown. According to the present invention, measurement of density and mass flow, allows the detection of these kind of fluctuations. In case of measuring such fluctuation, the catalyst feeding system can without delay be taken offline and a second parallel catalyst feeding system can be brought online according to the present invention. Reactor shutdown can accordingly be avoided.

FIG. 4 shows the concentration of catalyst monitored as a function of time when using the above method and device for supplying catalyst according to the invention. The online measurement of density and mass flow of the catalyst slurry shows that the catalyst feeding system is working accurately. A controlled amount of catalyst slurry is injected in the reactor at defined time points, which enables continuous preparation of the polymerization product.

1. Method for supplying a catalyst slurry to a reactor during a polymerization process whereby the catalyst slurry is periodically supplied to the reactor through at least one of a plurality of catalyst feeding conduits comprising the steps of:
determining an effective initial ratio solid catalyst particles/diluent for the polymerization process;
determining an actual ratio solid catalyst particles/diluent in a first catalyst feeding conduit;
calculating the difference between actual and initial ratio and in the event that said difference is more than a specified threshold, shutting down the catalyst slurry supply in the first catalyst feeding conduit and activating the catalyst slurry supply in a second catalyst feeding conduit.

2. Method according to claim 1, comprising injecting said catalyst slurry at regular time intervals to said reactor.

3. Method according to claim 1, comprising supplying a defined volume of catalyst slurry at regular time intervals to said reactor.

4. Method according to claim 2, wherein said regular time intervals consist of time intervals of every 5 to 30 seconds.

5. Method according to claim 1, wherein the actual ratio solid catalyst particles/diluent is determined continuously and on-line.

6. Method according to claim 1, wherein the actual ratio solid catalyst particles/diluent is determined by measuring the flow and density of the catalyst slurry, and by correlating said measured flow and density to the actual ratio solid catalyst particles/diluent.

7. Method according to claim 1 for optimising the supply of catalyst slurry to a reactor wherein polyethylene is prepared and wherein said catalyst is a chromium catalyst.

8. Polyolefin producing unit comprising:
a reactor system comprising at least one polymerization reactor,
means for feeding monomer, optionally co-monomer, and diluent to at least one polymerization reactor,
means for supplying a catalyst slurry consisting of solid catalyst particles suspended in a hydrocarbon diluent and characterised by a ratio of solid catalyst particles/diluent to said at least one polymerization reactor whereby said means comprise a storage vessel for storing catalyst slurry, which is operably connected to at least two parallel catalyst feeding conduits, whereby said conduits connect said storage vessel to said polymerization reactor,
one or more monomer and/or diluent recovery systems configured to recover unreacted monomer and/or diluent discharged from the polymerization reactor, and
a polyolefin processing system configured to process polyolefin particles produced in said polymerization reactor,
characterized in that each of said catalyst feeding conduits comprises:
an inlet, which is connected to said storage vessel and an outlet, which is connected to said reactor;
a metering device for measuring a defined volume of catalyst slurry and periodically releasing said defined volume from said storage vessel to said catalyst feeding conduits, and
a flow measuring device for determining the ratio of solid catalyst particles/diluent in said catalyst slurry, whereby said measuring device is provided on said catalyst feeding conduit downstream of said metering device.

9. Polyolefin producing unit according to claim 8 wherein said parallel catalyst feeding conduits are intermittently operative during the polymerisation process.

10. Polyolefin producing unit according to claim 8, wherein said catalyst feeding conduits comprise diluent injection means which are provided downstream of said metering device and upstream of said flow measuring device.

11. Polyolefin producing unit according to claim 8 wherein said catalyst feeding conduits are provided with valves for closing said conduits when not operative, whereby valves are provided on said conduits in between the storage vessel and the metering devices, and valves are provided on said conduits between the flow measuring means and the reactor.

12. Polyolefin producing unit according to claim 8, wherein said metering device is a ball check feeder valve.

13. Polyolefin producing unit according to claim 8, wherein said flow measuring device is a coriolis meter.
